(19) United States
(12) Patent Application Publication
(10) Pub. No.: US 2005/0195247 A1
(43) Pub. Date: Sep. 8, 2005

(54) Wire bonding method and liquid-jet head

(75) Inventors: Isao Yanagisawa, Nagano-ken (JP); Mutsuhiko Ota, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/071,573

(22) Filed: Mar. 4, 2005

(30) Foreign Application Priority Data
Mar. 5, 2004 (JP) 2004-063059
Nov. 24, 2004 (JP) 2004-338600

(51) Int. Cl. B41J 2/045

(52) U.S. Cl. 347/68

(57) ABSTRACT

A wire bonding method for connecting a bonding wire comprised of gold to a bonding pad comprises pressing the bonding wire against the bonding pad under a load of 78.4×10⁻³ N or less, while heating the bonding wire at a temperature of 100° C. or lower, and applying ultrasonic waves having a frequency of 100 to 120 KHz and an amplitude of 0.5 to 6 μm, thereby connecting the bonding wire to the bonding pad.

### CROSS REFERENCE TO RELATED APPLICATION

The entire disclosure of Japanese Patent Application No. 2004-338600 filed on Nov. 24, 2004, including specification, claims, drawings and summary, is incorporated herein by reference in its entirety.

### BACKGROUND OF THE INVENTION

1. Field of the Invention

This invention relates to a wire bonding method for a bonding wire to be connected to a bonding pad. More particularly, the invention relates to that which is preferred for application to a liquid-jet head where a portion of a pressure generating chamber communicating with a nozzle orifice for ejecting ink droplets is constituted of a vibration plate, a piezoelectric element is formed on the surface of the vibration plate, and ink droplets are ejected by displacement of a piezoelectric layer.

2. Description of the Prior Art

An actuator apparatus equipped with a piezoelectric element displaced by application of a voltage is installed, for example, on a liquid-jet head for jetting liquid droplets. Known as such a liquid-jet head is, for example, an ink-jet recording head in which a portion of a pressure generating chamber communicating with a nozzle orifice is constituted of a vibration plate, and the vibration plate is deformed by a piezoelectric element to pressurize ink in the pressure generating chamber, thereby ejecting ink droplets from the nozzle orifice. Two types of ink-jet recording heads are put into practical use. One of them is mounted with a piezoelectric actuator apparatus of longitudinal vibration mode which expands and contracts in the axial direction of the piezoelectric element. The other is mounted with a piezoelectric actuator apparatus of flexural vibration mode.

The latter ink-jet recording head adopts a structure in which a drive IC is installed on a plate bonded to a passage-forming substrate having the pressure generating chamber formed therein, for example, a reservoir forming plate, and the drive IC and a terminal portion of a lead electrode leading from each piezoelectric element are electrically connected together by a bonding wire by means of wire bonding (see, for example, Japanese Patent Application Laid-Open No. 2002-160366 (page 3, FIG. 2)). Wire bonding, which is performed in the production of such an ink-jet recording head, is carried out by connecting one end of a bonding wire to a terminal portion of the drive IC with the use of a capillary or the like, and then connecting the other end of the bonding wire to a bonding pad which is the terminal portion of the lead electrode.

Generally, wire bonding is performed while heating the bonding wire at a temperature of 150° C. or higher, and thus poses the problem that heating at such a high temperature causes thermal expansion of the respective plates or substrates constituting an ink-jet recording head, resulting in their destruction. In performing wire bonding in an ink-jet recording head, therefore, it is necessary to carry it out by heating at a low temperature of 100° C. or lower. However, wire bonding performed with heating at a low temperature involves the problem that an adequate bonding strength for bonding between a bonding wire and a bonding pad cannot be ensured.

Moreover, a high density is demanded of wiring for a device using a bonding wire, typified by an ink-jet recording head. With ordinary wire bonding, however, a bonding wire is connected to a bonding pad while being pressed against it under a load of 294 to 882×10⁻³ N. As a result, a stitch portion of the bonding wire connected to the bonding pad is formed with a stitch width of 2 to 3 times the diameter of the wire and a stitch thickness of not more than a tenth of the wire diameter. Thus, the bonding pad has to be formed with a larger width than the width of the stitch portion, posing the problem that it is impossible to achieve a high density by decreasing the width and the pitch of the bonding pad. In this view, a proposal has been made for an electrode structure for wire bonding in which a wire bonding portion of an electrode on a substrate is provided with a concave or a convex to forcibly secure a pressure bonding dimension for a bonding wire, ensure a bonding strength, and decrease the width and pitch of the electrode (see, for example, Japanese Patent Application Laid-Open No. 1993-251856 (pages 2 to 3, FIG. 1)).

The technology of this publication can ensure the same bonding strength as that of the conventional bonding wire. However, the problem arises that since the pressure bonding dimension is merely secured forcibly, the bonding strength cannot be increased. Also, this technology requires processing for providing the concave or convex at the wire bonding portion of the electrode, presenting the problems of a complicated manufacturing process and a high manufacturing cost. These problems are true of not only liquid-jet heads such as ink-jet recording heads, but also devices having a bonding wire connecting structure using semiconductor elements such as LSI and IC.

### SUMMARY OF THE INVENTION

The present invention has been accomplished in the light of the above-mentioned problems. It is an object of the invention to provide a wire bonding method and a liquid-jet head which can increase bonding strength and decrease the width and pitch of the bonding pad.

A first aspect of the present invention for attaining the above object is a wire bonding method for connecting a bonding wire comprised of gold to a bonding pad, comprising pressing the bonding wire against the bonding pad under a load of 78.4×10⁻³ N or less, while heating the bonding wire at a temperature of 100° C. or lower, and applying ultrasonic waves having a frequency of 100 to 120 KHz and an amplitude of 0.5 to 6 μm, thereby connecting the bonding wire to the bonding pad.

In the first aspect, even with wire bonding at a relatively low temperature, the bonding strength for bonding between the bonding wire and the bonding pad can be increased, the stitch width of the bonding wire connected to the bonding pad can be narrowed, the width of the bonding pad can be decreased, and the pitch between the bonding pad and an adjacent bonding pad can be decreased. Furthermore, with wire bonding at a low temperature, thermal expansion of a wire bonding apparatus can be suppressed, and the registration accuracy of wire bonding can be increased.

A second aspect of the wire bonding method of the present invention according to the first aspect is characterized in that the time of connecting the bonding wire to the bonding pad is the sum of a load variation convergence time during which the load converges to a desired load value and a bonding time.

In the second aspect, bonding can be performed by applying the ultrasonic waves in consideration of the load variation convergence time.

A third aspect of the wire bonding method of the present invention according to the second aspect is characterized in that the timing of applying the ultrasonic waves is a timing within the bonding time after the load variation convergence time.

In the third aspect, bonding can be performed by applying the ultrasonic waves when the load is stabilized after a lapse of the load variation convergence time.

A fourth aspect of the wire bonding method of the present invention according to the second aspect is characterized in that the load variation convergence time is 20 msec.

In the fourth aspect, the load variation time can be grasped reliably.

A fifth aspect of the wire bonding method of the present invention according to the first aspect is characterized in that the bonding pad comprises gold.

In the fifth aspect, the bonding wire comprising gold can be reliably bonded and the bonding strength can be increased by using the bonding pad comprising gold.

A sixth aspect of the wire bonding method of the present invention according to the first aspect is characterized in that the wire diameter of the bonding wire is 20 to 30 μm.

In the sixth aspect, the bonding wires can be connected to the bonding pads arranged at a high density.

A seventh aspect of the wire bonding method of the present invention according to the first aspect is characterized in that the amplitude of the ultrasonic waves is 3 μm or more.

In the seventh aspect, the bonding wire and the bonding pad can be reliably bonded together even when wire-bonded at a relatively low temperature, by using the ultrasonic waves having an amplitude of 3 μm or more.

An eight aspect of the present invention is a liquid-jet head comprising a vibration plate provided on a surface of a passage-forming substrate having pressure generating chambers defined therein, each of the pressure generating chambers communicating with a nozzle orifice; a plurality of piezoelectric elements each composed of a lower electrode, a piezoelectric layer, and an upper electrode provided via the vibration plate; and a bonding pad which is electrically connected to the piezoelectric element and to which a bonding wire is connected, and wherein the stitch width of the bonding wire connected to the bonding pad is 1.2 to 1.5 times the diameter of the wire, and the stitch thickness of the bonding wire connected to the bonding pad is 0.3 to 0.6 times the diameter of the wire.

In the eighth aspect, even with wire bonding at a relatively low temperature, the bonding strength for bonding between the bonding wire and the bonding pad can be increased, the stitch width of the bonding wire connected to the bonding pad can be narrowed, the width of the bonding pad can be decreased, and the pitch between the bonding pad and an adjacent bonding pad can be decreased. Thus, the reliability of the liquid-jet head can be increased, and the density of the piezoelectric elements can be rendered high. Furthermore, destruction of the liquid-jet head by thermal expansion can be prevented by wire bonding at a low temperature.

A ninth aspect of the liquid-jet head of the present invention according to the eighth aspect is characterized in that the bonding wire is connected to the bonding pad by pressing the bonding wire against the bonding pad under a load of 78.4×10⁻³ N or less, while heating the bonding wire at a temperature of 100° C. or lower, and applying ultrasonic waves having a frequency of 100 to 120 KHz and an amplitude of 0.5 to 6 μm.

In the ninth aspect, wire bonding is performed at a predetermined temperature, with predetermined ultrasonic waves, and under a predetermined load, whereby the bonding strength for bonding between the bonding wire and the bonding pad can be increased, and the stitch width of the bonding wire connected to the bonding pad can be narrowed.

A tenth aspect of the liquid-jet head of the present invention according to the ninth aspect is characterized in that the bonding wire is connected to the bonding pad such that the time of connecting the bonding wire to the bonding pad is the sum of a load variation convergence time during which the load converges to a desired load value and a bonding time.

In the tenth aspect, the liquid-jet head is provided by performing bonding while applying the ultrasonic waves inconsideration of the load variation convergence time.

An eleventh aspect of the liquid-jet head of the present invention according to the tenth aspect is characterized in that the bonding wire is connected to the bonding pad such that the timing of applying the ultrasonic waves is a timing within the bonding time after the load variation convergence time.

In the eleventh aspect, the liquid-jet head is provided by performing bonding while applying the ultrasonic waves when the load is stabilized after a lapse of the load variation convergence time.

A twelfth aspect of the liquid-jet head of the present invention according to the tenth aspect is characterized in that the bonding wire is connected to the bonding pad, with the load variation convergence time being set at 20 msec.

In the twelfth aspect, the liquid-jet head is provided by performing bonding, with the load variation time being grasped reliably.

A thirteenth aspect of the liquid-jet head of the present invention according to the eighth aspect is characterized in that the liquid-jet head has lead-out wiring leading from the piezoelectric element, and a front end portion of the lead-out wiring is the bonding pad.

In the thirteenth aspect, short-circuiting of the lead-out wiring, to which the bonding wire is connected, can be prevented, a high density of the lead-out wiring can be achieved, and the density of the piezoelectric elements can be rendered high.

A fourteenth aspect of the liquid-jet head of the present invention according to the eighth aspect is characterized in that the bonding wire has one end connected to a terminal portion of a drive IC for driving the piezoelectric element, and the bonding wire has the other end connected to the bonding pad.

In the fourteenth aspect, the bonding wire can be bonded, with high strength, to the bonding pad on a second bonding side, and the stitch width of the bonding wire can be narrowed.

A fifteenth aspect of the liquid-jet head of the present invention according to the fourteenth aspect is characterized in that a reservoir forming plate provided with a reservoir portion constituting a common liquid chamber for the pressure generating chambers is bonded to a surface of the passage-forming substrate facing the piezoelectric elements, and the drive IC is provided on the reservoir forming plate.

In the fifteenth aspect, a reservoir is formed by the reservoir forming plate, the bonding strength for bonding between the drive IC on the reservoir forming plate and other bonding pad can be increased, and the width of the bonding pad can be narrowed.

### BRIEF DESCRIPTION OF THE DRAWINGS

For a more complete understanding of the present invention and the advantages thereof, reference is now made to the following descriptions in conjunction with the accompanying drawings.

FIG. 1 is an exploded perspective view of a liquid-jet head according to an embodiment of the present invention.

FIGS. 2(a) and 2(b) are, respectively, a plan view of the liquid-jet head according to the embodiment of the present invention, and a sectional view taken on line A-A′ of FIG. 2(a).

FIG. 3 is a perspective view showing a connecting structure for wire bonding according to the present invention.

FIGS. 4(a) and 4(b) are sectional views of essential parts showing a wire bonding method according to an embodiment of the present invention.

FIGS. 5(a) to 5(c) are graphs showing the results of tests of wire bonding according to the present invention.

FIGS. 6(a) to 6(c) are time-charts illustrating examples of the statuses of load and ultrasonic waves.

FIGS. 7(a) and 7(b) are graphs showing the statuses of variations in a stitch width and pull-off strength.

### DESCRIPTION OF THE PREFERRED EMBODIMENTS

The present invention will now be described in detail based on the embodiments offered below.

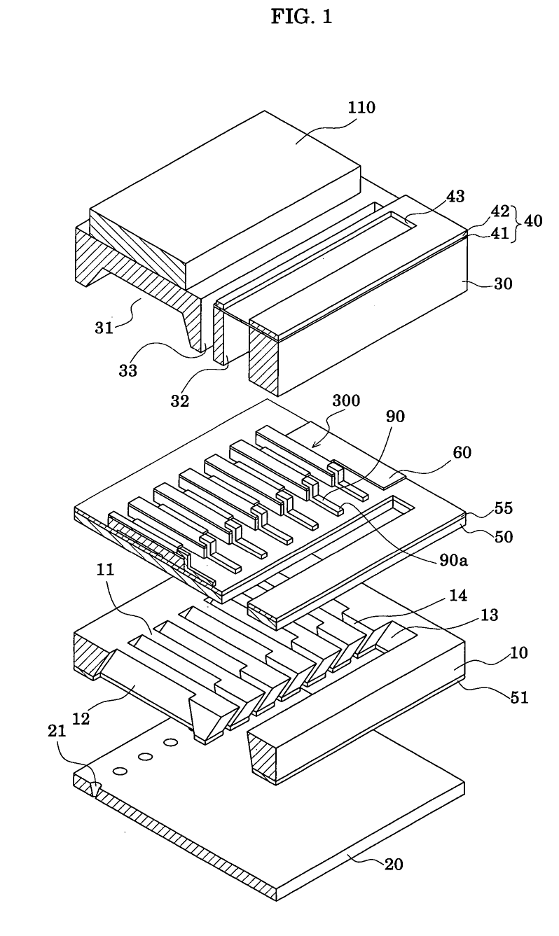

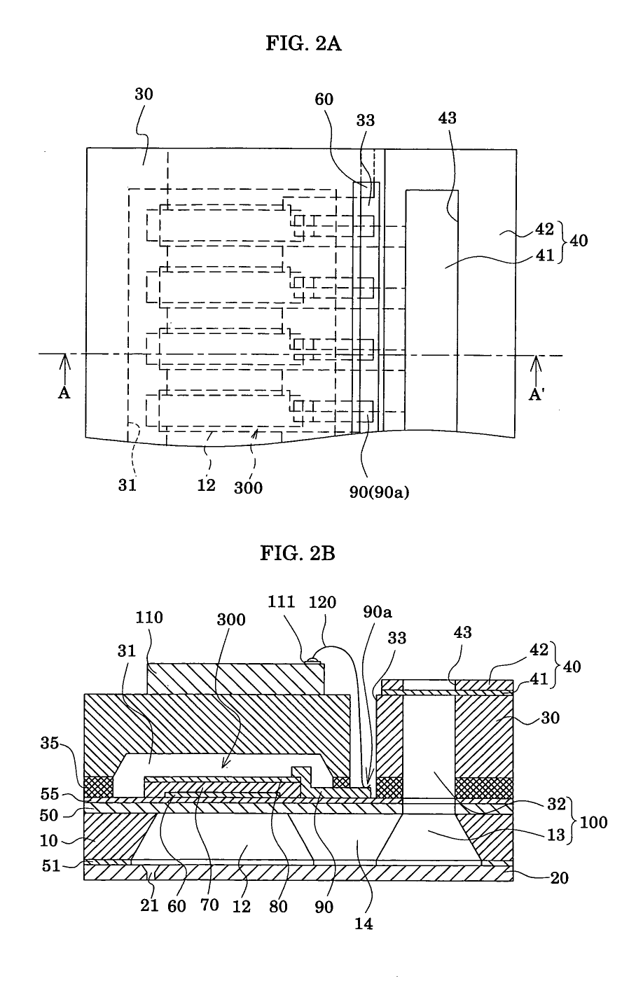

FIG. 1 is an exploded perspective view showing a liquid-jet head according to an embodiment of the present invention. FIG. 2(a) is a plan view of FIG. 1, and FIG. 2(b) is a sectional view of FIG. 2(a). A passage-forming substrate 10 constituting the liquid-jet head, in the present embodiment, consists of a single crystal silicon substrate. An elastic film 50, composed of silicon dioxide formed beforehand by thermal oxidation, is formed on one surface of the passage-forming substrate 10. In the passage-forming substrate 10, pressure generating chambers 12 divided by a plurality of compartment walls 11 are formed by anisotropic etching performed from the other surface of the passage-forming substrate 10. Longitudinally outwardly of the pressure generating chambers 12 arranged in a row, a communicating portion 13 is formed which communicates with a reservoir portion 32 provided in a reservoir forming plate 30 (to be described later on), and which constitutes a reservoir 100 serving as a common liquid chamber for the respective pressure generating chambers 12. The communicating portion 13 is also in communication with one end portion in the longitudinal direction of each pressure generating chamber 12 via a liquid supply path 14. Onto the opening surface of the passage-forming substrate 10, a nozzle plate 20 having nozzle orifices 21 bored therein is fixed via an adhesive agent or a heat sealing film. The nozzle orifices 21 communicate with the pressure generating chambers 12 on the side opposite to the liquid supply paths 14. The nozzle plate 20 comprises a glass ceramic, a single crystal silicon substrate, or rustless steel having a thickness of, for example, 0.01 to 1 mm, and a linear expansion coefficient of, for example, 2.5 to 4.5[×10−6/° C.] at 300° C. or below.

On the side opposite to the opening surface of the passage-forming substrate 10, the elastic film 50 having a thickness, for example, of about 1.0 μm is formed, as described above. An insulation film 55 having a thickness, for example, of about 0.4 μm is formed on the elastic film 50. On the insulation film 55, a lower electrode film 60 with a thickness, for example, of about 0.2 μm, a piezoelectric layer 70 with a thickness, for example, of about 1.0 μm, and an upper electrode film 80 with a thickness, for example, of about 0.05 μm are formed in a laminated state by a process (to be described later) to constitute a piezoelectric element 300. The piezoelectric element 300 refers to a portion including the lower electrode film 60, the piezoelectric layer 70, and the upper electrode film 80. Generally, one of the electrodes of the piezoelectric element 300 is used as a common electrode, and the other electrode and the piezoelectric layer 70 are constructed for each pressure generating chamber 12 by patterning. A portion, which is composed of any one of the electrodes and the piezoelectric layer 70 that have been patterned, and which undergoes piezoelectric distortion upon application of voltage to both electrodes, is called a piezoelectric active portion. In the present embodiment, the lower electrode film 60 is used as the common electrode for the piezoelectric elements 300, while the upper electrode film 80 is used as an individual electrode of each piezoelectric element 300. However, there is no harm in reversing their usages for the convenience of the drive circuit or wiring. In either case, it follows that the piezoelectric active portion is formed for each pressure generating chamber. Herein, the piezoelectric element 300 and a vibration plate, where displacement occurs by a drive of the piezoelectric element 300, are referred to as a piezoelectric actuator in combination.

In the foregoing example, the lower electrode film 60 of the piezoelectric element 300, the elastic film 50, and the insulation film 55 act as the vibration plate. A lead electrode 90 consisting of, say, gold (Au) extends as lead-out wiring led from a site near an end portion in the longitudinal direction of the upper electrode film 80 of the piezoelectric element 300 up to a site near an end portion of the pressure generating chamber 12 of the passage-forming substrate 10. This lead electrode 90 is electrically connected to a drive IC 110 (to be described later on) via a bonding wire 120 in a through-hole 33.

The reservoir forming plate 30, which has the reservoir portion 32 constituting at least a part of the reservoir 100, is bonded via an adhesive agent 35 onto the passage-forming substrate 10 on which the above-described piezoelectric elements 300 have been formed. The reservoir portion 32, in the present embodiment, is formed so as to penetrate the reservoir forming plate 30 in its thickness direction and extend in the width direction of the pressure generating chamber 12. The reservoir portion 32, as described earlier, is brought into communication with the communicating portion 13 of the passage-forming substrate 10 to constitute the reservoir 100 which serves as the common liquid chamber for the respective pressure generating chambers 12.

In a region of the reservoir forming plate 30 opposed to the piezoelectric elements 300, there is provided a piezoelectric element holding portion 31 which has such a space as not to impede the movement of the piezoelectric elements 300. In a region between the reservoir portion 32 and the piezoelectric element holding portion 31 of the reservoir forming plate 30, the through-hole 33 is provided which penetrates the reservoir forming plate 30 in its thickness direction. The lead electrode 90, which is the lead-out wiring leading from each piezoelectric element 300, has an end and an adjacent area exposed in the through-hole 33. The material for the reservoir forming plate 30 of such a configuration is, for example, glass, a ceramic material, a metal, or a resin. Preferably, the reservoir forming plate 30 is formed of a material having nearly the same thermal expansion coefficient as that of the passage-forming substrate 10. In the present embodiment, the reservoir forming plate 30 is formed from a single crystal silicon substrate which is the same material as that for the passage-forming substrate 10.

The drive IC 110 for driving each piezoelectric element 300 is provided on the reservoir forming plate 30. One end of the bonding wire 120 is connected to each terminal portion 111 of the drive IC 110, while the other end of the bonding wire 120 is connected to a terminal portion 90a of the lead electrode 90, which is a bonding pad, by a wire bonding method (the details of which will be described later). The wire diameter of the bonding wire 120 used in the present invention is 20 to 30 μm, and the bonding wire 120 having a wire diameter of 25 μm and comprising gold (Au) is used in the present embodiment.

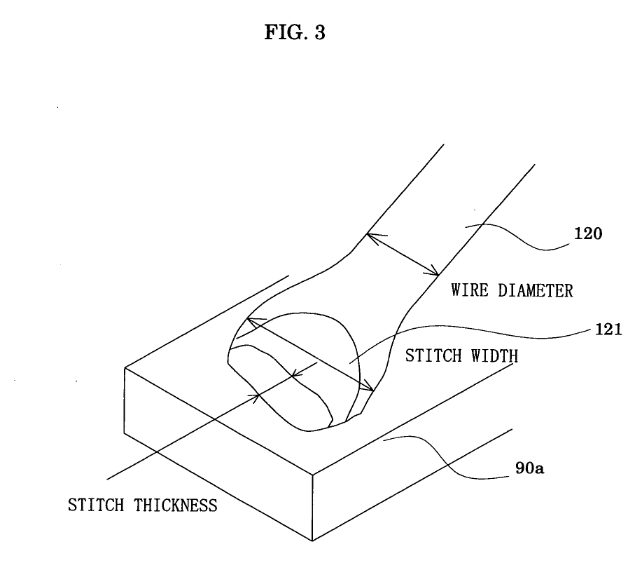

A connecting structure for the bonding wire 120 connected to the terminal portion 90a of the lead electrode 90 as the bonding pad will be described. FIG. 3 is a perspective view of this connecting structure. As shown in FIG. 3, a stitch portion 121, which is a region where one end of the bonding wire 120 is connected to the terminal portion 90a of the lead electrode 90, is formed in a partially lacking disk shape. The bonding wire 120 is connected by the wire bonding method (the details of which will be described later) such that the stitch width of the stitch portion 121 is 1.2 to 1.5 times the wire diameter, and the stitch thickness of the stitch portion 121 is 0.3 to 0.6 times the wire diameter. In the present embodiment, the bonding wire 120 with a wire diameter of 25 μm is used. Thus, the stitch portion 121 of the bonding wire 120 connected to the terminal portion 90a is formed with a stitch width of 30 to 37.5 μm and a stitch thickness of 7.5 to 15 μm. In the present embodiment, the stitch width refers to the maximum width of the stitch portion 121 connected to the terminal portion 90a at the end of the bonding wire 120, and the stitch thickness refers to the minimum thickness of the stitch portion 121.

As note above, the width of the stitch portion 121 of the bonding wire 120 connected to the terminal portion 90a as the bonding pad is narrowed, whereby the width of the terminal portion 90a can be narrowed, and the pitch between the terminal portion 90a and an adjacent terminal portion 90a can be decreased. Thus, the width and pitch of the lead electrode 90 can be rendered small, and the lead electrodes 90 can be arranged at a high density, and the liquid-jet head can be downsized.

A compliance plate 40 is bonded onto the reservoir forming plate 30. In a region of the compliance plate 40 opposed to the reservoir 100, a liquid introduction port 43 for supplying a liquid to the reservoir 100 is formed so as to penetrate the compliance plate 40 in its thickness direction. Of the region of the compliance plate 40 opposed to the reservoir 100, a region other than the liquid introduction port 43 is a flexible portion 41 which is formed to be thin in the thickness direction. The reservoir 100 is sealed with the flexible portion 41. The flexible portion 41 imparts compliance to the interior of the reservoir 100.

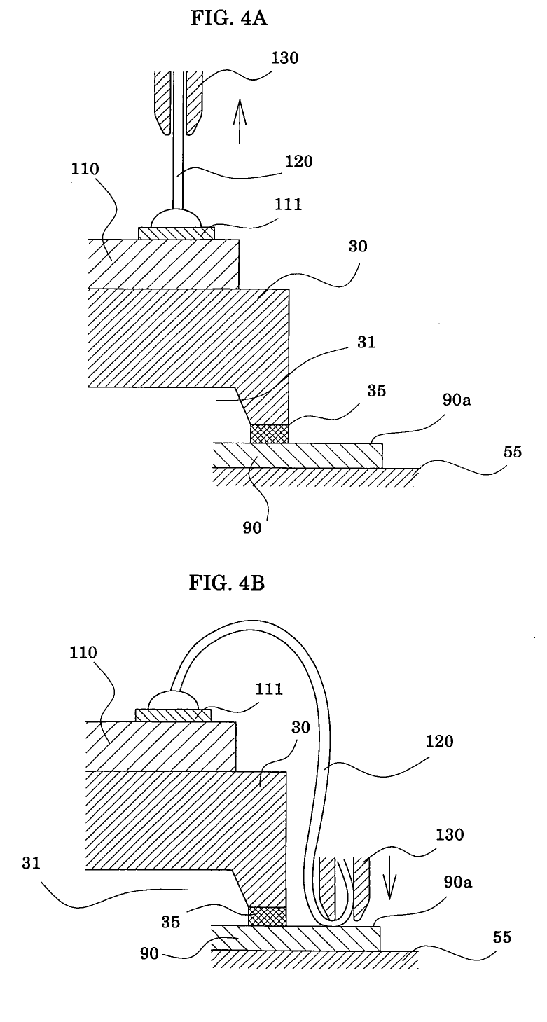

A wire bonding method for connecting the terminal portion 111 of the drive IC 110, as a bonding pad, to the terminal portion 90a of the lead electrode 90 by the bonding wire 120 will be described. FIGS. 4(a) and 4(b) are sectional views of the essential parts of the liquid-jet head illustrating the wire bonding method. As shown in FIG. 4(a), the bonding wire 120 is held by being inserted through a capillary 130 constituting a wire bonding apparatus, and is connected to the terminal portion 111 of the drive IC 110 by ball bonding. This connecting method by ball bonding is performed by fusing the front end of the bonding wire 120 to form a ball, and pressing this ball against the terminal portion 111 of the drive IC 110.

Then, as shown in FIG. 4(b), the bonding wire 120 is connected to the terminal portion 90a of the lead electrode 90 which is a bonding pad. At this time, the bonding wire 120 is connected by pressing the bonding wire 120 against the terminal portion 90a of the lead electrode 90 under a load of 78.4×10⁻³ N or less by means of the capillary 130 while heating the bonding wire 120 at a temperature of 100° C. or lower and applying ultrasonic waves having a frequency of 100 to 120 KHz and an amplitude of 0.5 to 6 μm, preferably 3 μm or more.

By this procedure, the stitch portion 121 of the bonding wire 120 connected onto the terminal portion 90a of the lead electrode 90 is formed in a partially lacking disk shape as shown in FIG. 3, and is formed such that its stitch width is 1.2 to 1.5 times the wire diameter, and its stitch thickness is 0.3 to 0.6 times the wire diameter.

In the present embodiment, the terminal portion 111 of the drive IC 110 and the terminal portion 90a of the lead electrode 90 are electrically connected by the bonding wire 120 connected by the above-described wire bonding method. The wire bonding method, and the connecting structure for the bonding wire, which have been described above, can be applied to all of the electrodes to be connected by the bonding wires of the liquid-jet head. Examples of the bonding wire other than that for the terminal portion 90a of the lead electrode 90 are a bonding wire for connecting the lower electrode film 60 and the drive IC 110, and a bonding wire for connecting a terminal portion of a wiring electrode, which is formed on the surface of the reservoir forming plate 30 bearing the drive IC 110, to the terminal portion of the drive IC 110, although such bonding wires are not shown.

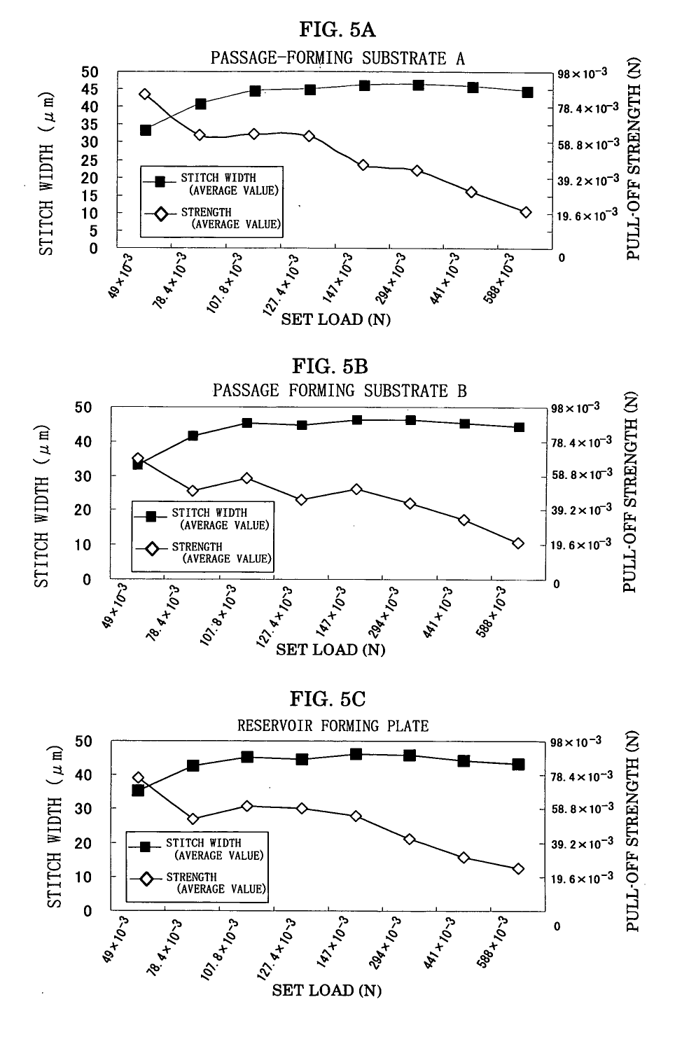

The terminal portion 90a of the lead electrode 90 was connected to each of two passage-forming substrates A and B and the reservoir forming plate 30 by the bonding wire 120 with a wire diameter of 25 μm with the use of a capillary having a tip diameter of 83 μm. On this occasion, connection was performed with heating at a temperature of 100° C. or lower while applying ultrasonic waves at a frequency of 100 to 120 KHz and an amplitude of 0.5 to 6 μm, with the load by the capillary 130 being varied during connection. FIGS. 5(a) to 5(c) show the results of measurements of the average values of the stitch width and pull-off strength of the stitch portion 121 of the bonding wire 120 connected under each load.

As shown in FIGS. 5(a) to 5(c), when wire bonding in any of the substrates and the plate was performed under a load of 78.4×10⁻³ N or less, the stitch width of the stitch portion 121 of the bonding wire 120 was narrower than that obtained when wire bonding was performed under a load of greater than 78.4×10⁻³ N. The reason for this is that the lower the load, the smaller the amount of the bonding wire crushed becomes. The measurement of the pull-off strength of the bonding wire 120 connected to each substrate or plate under each load showed that the pull-off strength was greater for connection under a low load of 78.4×10⁻³ N or less than for connection under a load higher than this load.

These results show that by connecting the bonding wire 120 to the terminal portion 90a of the lead electrode 90, as the bonding pad, under a load of 78.4×10⁻³ N or less with heating at a temperature of 100° C. or lower while applying ultrasonic waves at a frequency of 100 to 120 KHz and an amplitude of 0.5 to 6 μm, the stitch width can be narrowed, and the bonding strength for bonding between the bonding wire 120 and the bonding pad can be increased. Consequently, a liquid-jet head with a bonded wire that is difficult to peal and that is with highly reliability can be provided. Furthermore, the width of the bonding pad and the pitch of the bonding pads can be decreased to render the liquid-jet head high in density and small in size.

Also, the application of ultrasonic waves with a frequency of 100 to 120 KHz and an amplitude of 0.5 to 6 μm enables wire bonding to be performed by heating at a relatively low temperature of 100° C. or lower. Thus, the destruction of the liquid-jet head by thermal expansion can be prevented. Moreover, wire bonding performed by heating at a relatively low temperature of 100° C. or lower can prevent the thermal expansion of the wire bonding apparatus which is composed of a horn for holding the capillary 130, and a camera, etc. used in the registration of the capillary 130. Thus, even if the horn and the camera are formed as separate members, there is no failure in the registration of wire bonding because of misalignment of the capillary 130 by the camera due to thermal expansion. As a result, high precision wire bonding can take place, and destruction of the wire bonding apparatus due to heat can be prevented. Furthermore, wire bonding at a relatively low temperature can result in energy savings.

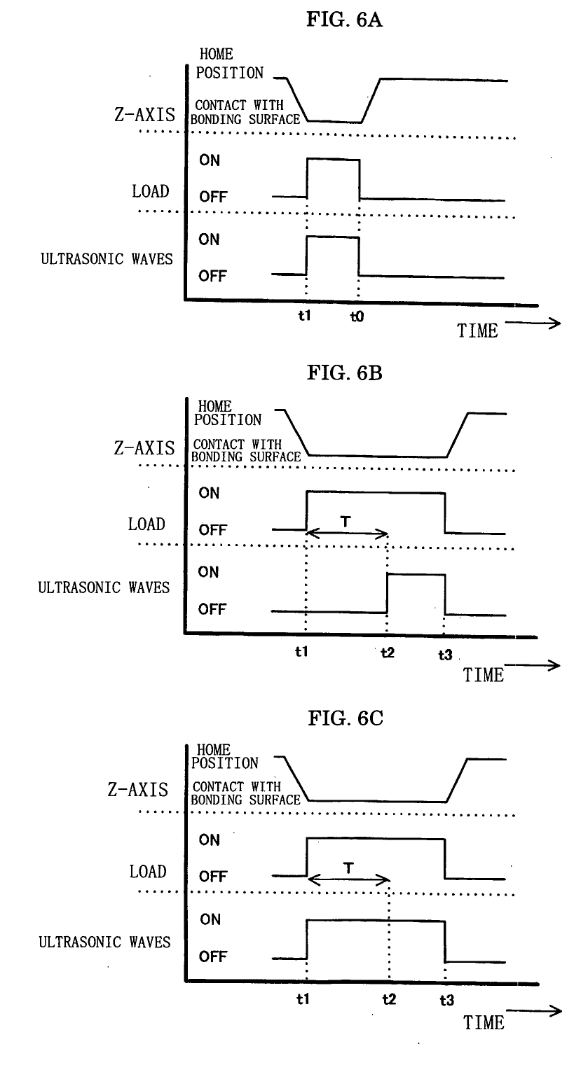

The statuses of the load (the position of the capillary 130 (see FIGS. 4(a) and 4(b) in the Z-axis direction) and the ultrasonic waves in wire bonding will be described based on FIGS. 6(a) to 6(c). FIGS. 6(a) to 6(c) show time-charts illustrating examples of the statuses of the load and the ultrasonic waves in wire bonding.

In the example shown in FIG. 6(a), the capillary 130 (see FIGS. 4(a) and 4(b)) is lowered from its home position, and contacts a bonding surface at a time t1. At the time t1, the load is applied, that is to say, becomes ON, and ultrasonic waves are applied, that is to say, become ON. During the period, i.e., bonding time, from the time t1 to a time t0 (for example, a period of 5 to 10 msec), the load and the ultrasonic waves are ON and, at the time t0, bonding ends. That is, at the time t0, the capillary 130 (see FIGS. 4(a) and 4(b)) ascends to the home position, bringing the load and the ultrasonic waves into the OFF state.

In the example shown in FIG. 6(a), bonding at a low temperature can be performed in a predetermined bonding time.

In the example shown in FIG. 6(b), the capillary 130 (see FIGS. 4(a) and 4(b)) is lowered from its home position, and contacts a bonding surface at a time t1, when the load is applied, that is to say, becomes ON. An initial load varies in a range of the order of minus 20×10⁻³ N from a set load (for example, 78.4×10⁻³ N), and there is a load variation convergence time T until a time t2 when the load becomes stable and reaches the set load. Thus, after a lapse of the load variation convergence time T, ultrasonic waves are applied, that is to say, become ON at the time t2. During the period, i.e., bonding time, from the time t2 to a time t3 (for example, a period of 5 to 10 msec), the load and the ultrasonic waves are ON and, at the time t3, bonding ends. That is, at the time t3, the capillary 130 (see FIGS. 4(a) and 4(b)) ascends to the home position, bringing the load and the ultrasonic waves into the OFF state.

In the example shown in FIG. 6(b), bonding at a low temperature can be performed by applying ultrasonic waves under a load which is stable at the set load. Thus, the stitch shape and the bonding strength can be stably ensured by applying a minimum level of ultrasonic waves.

In the example shown in FIG. 6(c), the capillary 130 (see FIGS. 4(a) and 4(b)) is lowered from its home position, and contacts a bonding surface at a time t1, when the load is applied, that is to say, becomes ON. At the same time, ultrasonic waves are applied, that is to say, become ON. An initial load varies in a range of the order of minus 20×10⁻³ N from a set load (for example, 78.4×10⁻³ N), and there is a load variation convergence time T until a time t2 when the load becomes stable and reaches the set load. Thus, after a lapse of the load variation convergence time T, the load and ultrasonic waves continue to be applied, that is to say, are kept ON during the period, i.e., bonding time, from the time t2 to a time t3 (for example, a period of 5 to 10 msec) and, at the time t3, bonding ends. That is, at the time t3, the capillary 130 (see FIGS. 4(a) and 4(b)) ascends to the home position, bringing the load and the ultrasonic waves into the OFF state.

In the example shown in FIG. 6(c), bonding at a low temperature can be performed by applying ultrasonic waves, starting from a state before the load becomes stable at the set load. Thus, the stitch shape and the bonding strength can be ensured stably and reliably.

In addition, the ON and OFF operations of the load and ultrasonic waves can be performed such that the load or the frequency of the ultrasonic waves is progressively increased or progressively decreased to be brought into a predetermined state.

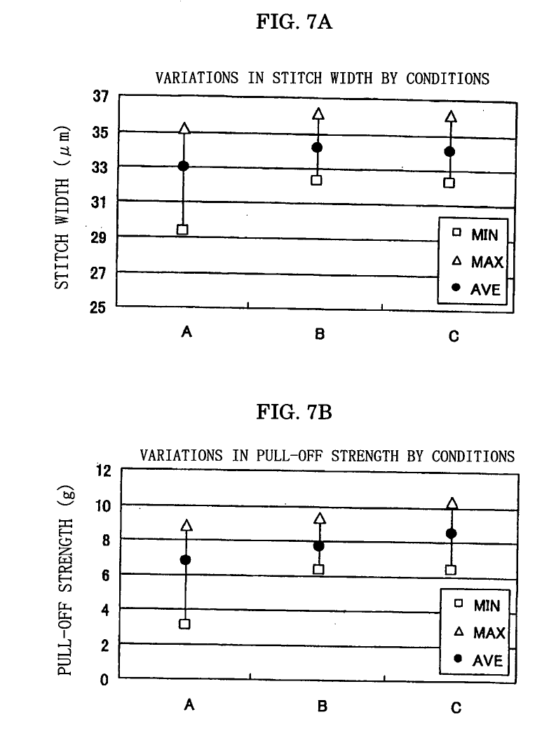

FIG. 7(a) shows the status of variations in the stitch width when wire bonding was performed in the states shown in FIGS. 6(a) to 6(c). FIG. 7(b) shows the status of variations in the pull-off strength when wire bonding was performed in the states shown in FIGS. 6(a) to 6(c). In FIGS. 7(a) and 7(b), A, B, and C represent the states of FIGS. 6(a), 6(b) and 6(c), respectively.

As shown in FIG. 7(a), variations in the stitch width remain in a practical range of 29 μm to 36 μm. Particularly when ultrasonic waves are applied in consideration of the load variation convergence time T, variations in the stitch width are found to be confined in a narrow range of 32 to 36 μm. Thus, it can be found that the stitch shape can be ensured stably by applying ultrasonic waves, with variations in load being taken into consideration.

As shown in FIG. 7(b), variations in the pull-off strength remain in a practical range of 3 g to 11 g. Particularly when ultrasonic waves are applied in consideration of the load variation convergence time T, variations in the pull-off strength are found to be confined in a high-value range of 6 g to 11 g. Thus, it can be found that the bonding strength can be ensured stably by applying ultrasonic waves, with variations in load being taken into consideration.

The above-described embodiments illustrate the wire bonding method used on the liquid-jet head, and the connecting structure for the bonding wire that has been formed by this method. However, the present invention is not limited to them, and can be applied to other devices using a bonding wire, such as semiconductor devices. It should be understood that such changes, substitutions and alterations can be made therein without departing from the spirit and scope of the invention as defined by the appended claims.

1. A wire bonding method for connecting a bonding wire comprised of gold to a bonding pad, comprising:
pressing the bonding wire against the bonding pad under a load of 78.4×10⁻³ N or less, while heating the bonding wire at a temperature of 100° C. or lower, and applying ultrasonic waves having a frequency of 100 to 120 KHz and an amplitude of 0.5 to 6 μm, thereby connecting the bonding wire to the bonding pad.

2. The wire bonding method according to claim 1, wherein a time of connecting the bonding wire to the bonding pad is a sum of a load variation convergence time during which the load converges to a desired load value and a bonding time.

3. The wire bonding method according to claim 2, wherein a timing of applying the ultrasonic waves is a timing within the bonding time after the load variation convergence time.

4. The wire bonding method according to claim 2, wherein the load variation convergence time is 20 msec.

5. The wire bonding method according to claim 1, wherein the bonding pad comprises gold.

6. The wire bonding method according to claim 1, wherein a wire diameter of the bonding wire is 20 to 30 μm.

7. The wire bonding method according to claim 1, wherein the amplitude of the ultrasonic waves is 3 μm or more.

8. A liquid-jet head comprising:
a vibration plate provided on a surface of a passage-forming substrate having pressure generating chambers defined therein, each of the pressure generating chambers communicating with a nozzle orifice;
a plurality of piezoelectric elements each composed of a lower electrode, a piezoelectric layer, and an upper electrode provided via the vibration plate; and
a bonding pad which is electrically connected to the piezoelectric element and to which a bonding wire is connected, and
wherein a stitch width of the bonding wire connected to the bonding pad is 1.2 to 1.5 times a diameter of the bonding wire, and a stitch thickness of the bonding wire connected to the bonding pad is 0.3 to 0.6 times the wire diameter.

9. The liquid-jet head according to claim 8, wherein the bonding wire is connected to the bonding pad by pressing the bonding wire against the bonding pad under a load of 78.4×10⁻³ N or less, while heating the bonding wire at a temperature of 100° C. or lower, and applying ultrasonic waves having a frequency of 100 to 120 KHz and an amplitude of 0.5 to 6 μm.

10. The liquid-jet head according to claim 9, wherein the bonding wire is connected to the bonding pad such that a time of connecting the bonding wire to the bonding pad is a sum of a load variation convergence time during which the load converges to a desired load value and a bonding time.

11. The liquid-jet head according to claim 10, wherein the bonding wire is connected to the bonding pad such that a timing of applying the ultrasonic waves is a timing within the bonding time after the load variation convergence time.

12. The liquid-jet head according to claim 10, wherein the bonding wire is connected to the bonding pad, with the load variation convergence time being set at 20 msec.

13. The liquid-jet head according to claim 8, wherein the liquid-jet head has lead-out wiring leading from the piezoelectric element, and a front end portion of the lead-out wiring is the bonding pad.

14. The liquid-jet head according to claim 8, wherein the bonding wire has one end connected to a terminal portion of a drive IC for driving the piezoelectric element, and the bonding wire has another end connected to the bonding pad.

15. The liquid-jet head according to claim 14, wherein a reservoir forming plate provided with a reservoir portion constituting a common liquid chamber for the pressure generating chambers is bonded to a surface of the passage-forming substrate facing the piezoelectric elements, and the drive IC is provided on the reservoir forming plate.
